(19) United States
(12) Patent Application Publication
(10) Pub. No.: US 2019/0209931 A1
(43) Pub. Date: Jul. 11, 2019

(54) SIX DISK GAME CHANGER

(71) Applicants: DeAnn Cleland, Louisville, KY (US); James Cleland, Louisville, KY (US)

(72) Inventors: DeAnn Cleland, Louisville, KY (US); James Cleland, Louisville, KY (US)

(21) Appl. No.: 15/864,488

(22) Filed: Jan. 8, 2018

(51) Int. Cl. A63F 13/98; G11B 17/22; G11B 33/10

(52) U.S. Cl. CPC A63F 13/98; A63F 2300/20; G11B 33/10; G11B 17/22

(57) ABSTRACT

The present invention is six disk game changer having light indicators alongside CD inserts. The six disk game changer has a connectivity source.

### BACKGROUND OF THE INVENTION

### Field of the Invention

The present invention is in the field of consumer electronics. More specifically, the present invention is a six disk game changer.

### Description of the Related Art

The present invention is a six disk game changer has four separate items a disk game changer, light indicator, slots and connectivity source. The main purpose of the six disk game changer is to present a disc changer with multiple ports for gaming consoles. In the modern age of technology, a popular pastime is playing video games on consoles such as: Playstation, Xbox, and Wii. However, current gaming systems consist of a sole disc changer requiring players to walk to their system, open the tray, remove the disc, and insert a new one—this process entails constant handling of fragile discs which increases the chances of accidental damage or breakage. Ingenious and practical, the six disk game changer introduces an apparatus compatible with gaming consoles which permits consumers to have multiple games inserted and ready to play, removing the constant need to switch discs manually. Simple to use, one may connect the disc game changer via USB, HDMI, Bluetooth or Wi-Fi to their owned gaming console, then insert up to six games within the slots. Once an individual decides they want to play a certain game, using their controller, they may conveniently select the desired game from the system's home screen, enabling the console to read the disc and load the game. The six disk game changer can easily become an essential additive to gaming consoles, making it possible to be readily available at electronic stores and/or online retailers. The six disk game changer is the only product of its kind to offer a compact device which facilitates the disc swapping process for gamers. The six disk game changer is uniquely designed with LED light indicator for each slot, which effectively illuminates when a disc is inside the respected opening and ready for utilization.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a six disk game changer, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

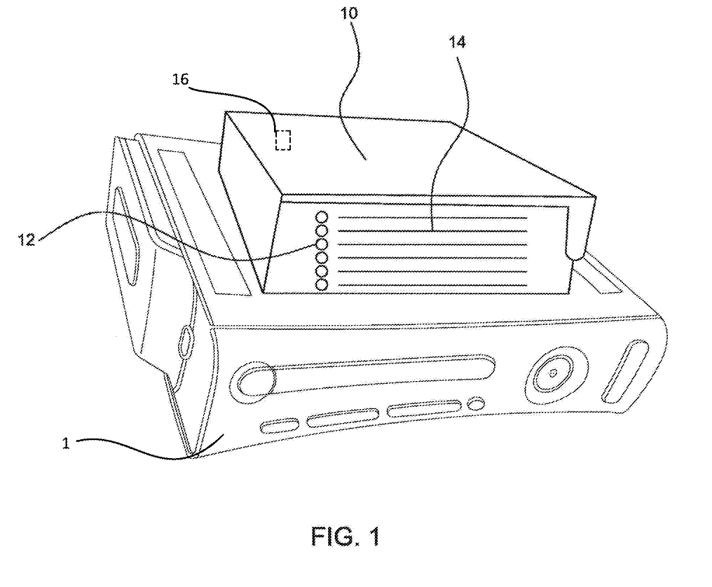

Referring now to FIG. 1, illustrated is a six disk game changer, in accordance with one embodiment of the present invention. In FIG. 1, illustrated is a six disk game changer 10 with light indicators 12. Shown is CD inserts 14.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A six disc game changer, comprising:
a plurality of slots; and
a plurality of light indicators disposed near the plurality of slots to illuminate in response to a game disc being inserted within at least one of the plurality of slots, such that a diameter of each of the plurality of light indicators exceed a height of an opening of the plurality of slots.

2. The six disc game changer according to claim 1, wherein the six disc game changer has a connectivity source.

3. The six disc game changer according to claim 1, wherein the six disc game changer connects via USB, HDMI, Bluetooth or Wi-Fi to a gaming console.

4. A six disc game changer, comprising:
a housing to store at least one game disc therein;
a plurality of slots disposed on at least a portion of a first side of the housing to receive the at least one game disc; and
a plurality of light indicators disposed on at least a portion of the first side of the housing to illuminate in response to the at least one game disc being inserted within at least one of the plurality of slots, such that each of the plurality of light indicators are disposed at a predetermined angle with respect to a first edge of the housing and parallel with respect to a second edge of the housing.
